(19) United States
(12) Patent Application Publication
(10) Pub. No.: US 2026/0238477 A1
(43) Pub. Date: Aug. 13, 2026

(54) HOST AND CLIENT DEVICES, A WIRE-BASED NETWORK AND METHODS THEREOF

(71) Applicant: Infineon Technologies AG, Neubiberg (DE)

(72) Inventors: Daniel MYSLIWITZ, Unterschleißheim (DE); Manuela MEIER, Muenchen (DE)

(21) Appl. No.: 19/457,243

(22) Filed: Jan. 23, 2026

(30) Foreign Application Priority Data
Feb. 12, 2025 (DE) 102025105234.4

(51) Int. Cl. H04L 9/32; H04L 1/08; H04L 9/08

(52) U.S. Cl. CPC H04L 9/32; H04L 1/08; H04L 9/08

(57) ABSTRACT

The present disclosure relates to host and client devices, a wire-based network and methods thereof. The host device includes a processing circuit configured to generate an authentic beacon by providing a base beacon with an authentication feature, and a transmit circuit configured to transmit the authentic beacon to a wire-based multidrop network for synchronous initiation of a transmission cycle. The client device includes a receive circuit configured to receive a beacon from a wire-based multidrop network, and a processing circuit configured to check if the beacon is an authentic beacon. The network disclosed includes the host device and at least one client device.

### CROSS-REFERENCE TO RELATED APPLICATION

This application claims priority to Germany Patent Application No. 102025105234.4 filed on Feb. 12, 2025, the content of which is incorporated by reference herein in its entirety.

### TECHNICAL FIELD

The present disclosure relates to wire-based multidrop networks, in particular host and client devices for such networks and methods of host and client devices.

### BACKGROUND

Ethernet is a widely used technology for local area networks (LANs), providing a standardized way for devices to communicate over wire-based networks. It operates on the principles of packet-based communication, where data is transmitted in frames between devices.

In some networks, e.g., in 10BASE-T1S networks, communication involves periodic transmission of a synchronization signal, also referred to as beacon, to coordinate timing between devices on a shared bus, ensuring collision-free data exchange. As the beacon synchronizes all clients on a wire-based multidrop network, an attacking beacon may impact the complete network.

### SUMMARY

According to some implementations, a host device of claim 1, a client device of claim 7, a wire-based network of claim 16 and methods of claim 17 and 24 are provided. The dependent claims define further implementations.

According to an implementation, a host device includes a processing circuit configured to generate an authentic beacon by providing a base beacon with an authentication feature, and a transmit circuit configured to transmit the authentic beacon to a wire-based multidrop network for synchronous initiation of a transmission cycle.

According to another implementation, a client device includes a receive circuit configured to receive a beacon from a wire-based multidrop network, and a processing circuit configured to check if the beacon is an authentic beacon.

In some implementations, a wire-based multidrop network includes the above host device and at least one client device explained above.

According to an implementation, a method includes generating, by a processing circuit of a host device, an authentic beacon by providing a base beacon with an authentication feature, and transmitting, by a transmit circuit of the host device, the authentic beacon to a wire-based multidrop network for synchronous initiation of a transmission cycle.

According to another implementation, a method includes receiving, by a receive circuit of at least one client device, a beacon from a wire-based multidrop network, and checking, by a processing circuit of the at least one client device, if the beacon is an authentic beacon.

### BRIEF DESCRIPTION OF THE DRAWINGS

FIG. 1 illustrates an implementation of a wire-based multidrop network.

FIG. 2 illustrates an implementation of a host device.

FIG. 3 illustrates an implementation of a client device.

FIG. 4 is a flowchart illustrating a method according to an implementation.

FIG. 5 is a flowchart illustrating a method according to an implementation.

FIG. 6 illustrates an implementation of a transmission scheme of the wire-based multidrop network.

### DETAILED DESCRIPTION

In the following, implementations will be described in detail with reference to the accompanying drawings. It is to be understood that the following description of implementations is not to be taken in a limiting sense. The scope of the application is not intended to be limited by the implementations described hereinafter or by the drawings, which are taken to be illustrative only.

The drawings are to be regarded as being schematic representation and elements illustrated in the drawings are not necessarily shown to scale. Rather, the various elements are represented such as a function in general purpose becomes apparent to a person skilled in the art. Any connection or coupling between functional blocks, devices, components or other physical or functional units shown in the drawings or described herein may also be implemented by an indirect connection or coupling. Functional blocks may be implemented in hardware, firmware, software or a combination thereof.

Throughout the figures and the description, same reference numbers are used to describe same features or components.

Generally, beacon-based transmission schemes involve a host device transmitting a beacon to a network, prompting connected client devices to respond by sending data back to the host device. Beacons may be used to coordinate communication between multiple devices on a shared medium and may be a simple synchronization signal, such as a basic pulse or a specific pattern. The transmission of the beacon by the host device may initiate a transmission cycle, meaning all network nodes may be synchronized and assigned transmission opportunities. During the transmission opportunity of a client device, the client device may transmit data. After a full transmission cycle in which each network node has been allowed to transmit data to the network, another beacon may be transmitted by the host device to initiate another transmission cycle.

In a potential attack scenario of the network, one of the connected devices may act as an intruder sending an invalid beacon to the network, which may initiate a new transmission cycle even though a previous transmission cycle has not been completed. As a result, client devices with transmission opportunities subsequent to the intruder are no longer able to transmit data to the network and are thus excluded from communication.

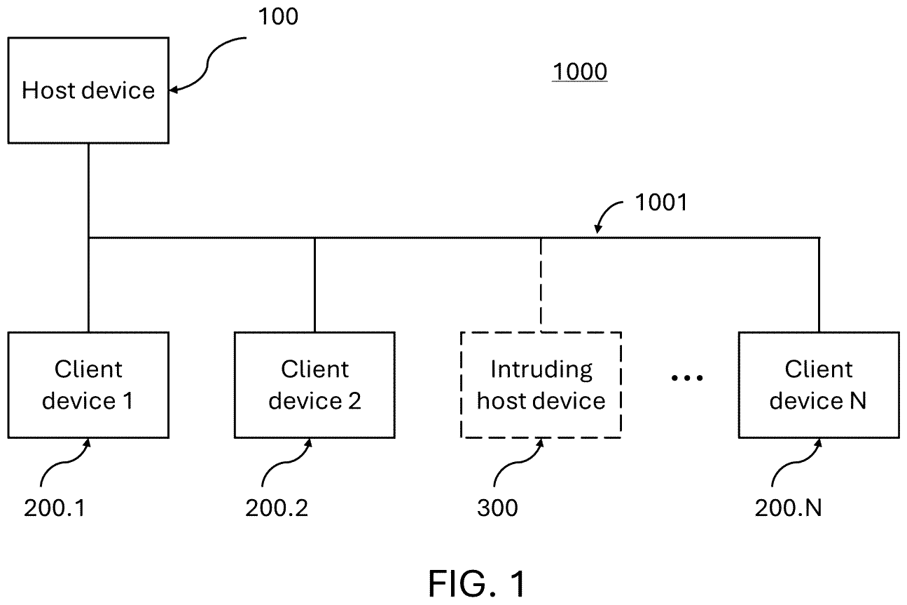

FIG. 1 illustrates an implementation of a wire-based multidrop network 1000. A wire-based multidrop network is a type of communication network where multiple devices (network nodes) are connected to a bus such that all devices share the same transmission medium. The wire-based multidrop network 1000 comprises a host device 100 and client devices 200, wherein a plurality of client devices 200.1 to 200.N are possible. For example, the wire-based multidrop network 1000 may comprise four, five, eight, 13 or a plurality of client devices 200. Without proper access control, it is possible that unauthorized devices, such as intruding host device 300, connect to the wire-based network 1000, potentially launching attacks, e.g., by providing beacons to steal data or disrupt communication.

The host device 100 and the client devices 200 communicate via a bus 1001. In some implementations, the bus 1001 may be a wire, for example a two-wire cable. The two-wire cable may comprise a single pair of conductors, e.g., Single Pair Ethernet (SPE). The wire of bus 1001 may, for example, be of a length below 10 m or a length of 15 m, 25 m or even 100 m. The bus 1001 may be half-duplex, meaning a device of the network 1000 may either transmit or receive data. In this case, devices on the bus may work via time multiplexing, wherein each client device may be assigned to a specific time slot such that each client may transmit data without collisions. The bus 1001 may operate at 10 Mbit/s, 100 Mbit/s or 1 Gbit/s.

SPE is a modern ethernet standard configured to transmit data over a single twisted pair of wires, reducing cabling complexity compared to traditional ethernet, which typically uses two or four pairs. SPE, such as 10BASE-T1S, simplifies network infrastructure, particularly in automotive environments, where space is limited.

SPE according to standard IEEE 802.3cg-2019, such as 10BASE-T1S, 100BASE-T1S, 10BASE-T1M or the like, may work on beacon-based communication. With reference to the Open Systems Interconnection (OSI) model, a beacon links layer 1 and layer 2 of the OSI model, corresponding to the Physical Layer and the Data Link Layer. Standardized security protocols for wire-based networks, such as Media Access Control Security often address protecting data frames transmitted over a network securing communication of layer 2. According to aspects of the disclosure, communication between layer 1 and layer 2 is addressed to secure data transmission or control connection of unauthorized devices. It may be noted that modern standards such as 10BASE-T1S may fall out of scope of established secure communication protocols.

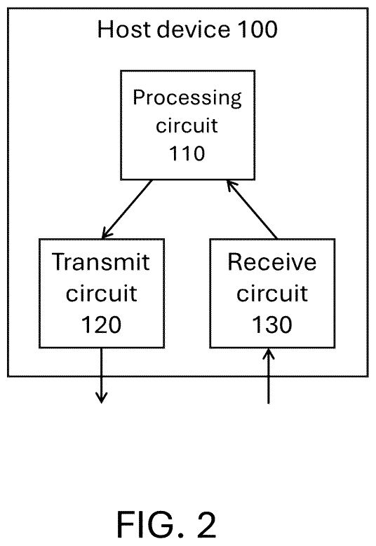

FIG. 2 illustrates a host device 100 according to an implementation. The host device 100 comprises a processing circuit 110, a transmit circuit 120, and a receive circuit 130. The processing circuit 110 may be configured to generate an authentic beacon, comprising a base beacon and an authentication feature. The processing circuit 110 may include one or more processors (e.g., hardware processors) configured to generate the authentic beacon and perform other processing-based functions described herein.

Beacons in network protocols are typically generated following specific guidelines defined by the relevant network standards and the base beacon may be generated in compliance with the applicable network standard. The base beacon may be a simple synchronization signal. It may be a basic pulse or a specific pattern that serves to mark the beginning of a transmission cycle. For example, the beacon may be transmitted in plaintext and may comprise a cycle counter. In some implementations, the base beacon may be a frame-based beacon structured as a data frame comprising a header with information such as, but not limited to, the source ID, network time, or slot assignments. The base beacon may comprise timing information that define specific time slots for each client device on the network, for example specific time slots during which a client device is permitted to transmit data. In other implementations, the base beacon may comprise frequency information, defining specific frequency channels for each client device on the network, for example specific frequencies at which a client device is permitted to transmit.

In some implementations, the authentication feature is based on an encryption key. The encryption key may use any crypto algorithm, e.g., GCM-AES-128. For example, the authentication feature may be a dynamically generated value, e.g., an integrity check value. In another example, the authentication feature may be a static key which is preinstalled to all authentic network devices.

For example, the authentication feature may be appended to the base beacon or prepended to the base beacon. If the base beacon is a frame-based beacon, the authentication feature may be a separate frame or may be part of a frame, e.g., part of the header. In some implementations, if the authentication feature is a separate authentication feature, e.g., a separate data frame comprising the authentication feature, a backward compatibility may be possible such that legacy slaves may be able to receive the authentic beacon, recognize the base beacon and may function according to conventional communication without the authentication.

The key may be updated by the host device, wherein in some implementations, a key update may be performed in a synchronized way, wherein all network nodes may switch to a new key at once. The key update may be performed at any time during operation, wherein a new key may become active after a reset or a power-up.

The authentic beacon generated by processing circuit 110 is forwarded to the transmit circuit 120 that is configured to transmit the authentic beacon to a wire-based multidrop network, e.g., network 1000, for synchronous initiation of a transmission cycle.

The transmission cycle organizes transmit opportunities on the bus and may work via frequency multiplexing or time multiplexing. In time multiplexing, the transmission cycle may optionally comprise fixed-length time slots or dynamically allocated time slots based on demand. During the transmission cycle, each client device may be assigned to a specific time slot such that each client may transmit data without collisions. In frequency multiplexing, the available bandwidth may be divided into different frequency channels of a spectrum. Each client device may be assigned a separate frequency channel within the spectrum. This way, during a transmission cycle, multiple devices may transmit data simultaneously, but on different frequencies. This may prevent interference because each device may operate on a distinct channel.

The receive circuit 130 may be configured to receive data in response to the transmission of the authentic beacon from the network, e.g., from a client device 200 of network 1000. Such data may comprise, but is not limited to, sensor measurements, control signals, diagnostic and/or configuration data. In some implementations, the received data may comprise a notification from a client device 200 indicating that it has previously received an invalid beacon. This may be indicative of a potential attack and the host device may take specific actions to control connection of unauthorized devices and ensure the security of the network. Among other possibilities, the specific actions may, for example, comprise the triggering of an alarm and/or the deactivation of a system or a portion of a system. The specific actions may be dependent on functionalities of the concerning client and/or network.

To analyze the data, it is forwarded to processing circuit 110. The processing circuit 110 of host device 100 (e.g., the one or more processors of the processing circuit 110) may be configured to analyze the data and/or respond to the data, which may comprise, but is not limited to monitoring data, data logging, diagnostics and fault detection, issuing control commands, and/or authenticating client devices to ensure secure operation.

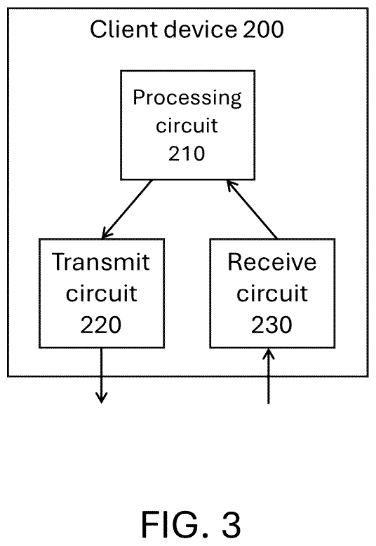

FIG. 3 illustrates a client device 200 according to one implementation. The client device 200 comprises a processing circuit 210, a transmit circuit 220, and a receive circuit 230. The receive circuit 230 may be configured to receive a beacon from a wire-based multidrop network, e.g., network 1000. The beacon is then forwarded to the processing circuit 210, which may be configured to check if the beacon is an authentic beacon. The processing circuit 210 may include one or more processors (e.g., hardware processors) configured to check if the beacon is an authentic beacon and perform other processing-based functions described herein.

For example, checking if the beacon is an authentic beacon comprises verifying presence of an authentication feature of the authentic beacon. If present, the authentication feature may be validated which may comprise validating an encryption key-based value based on any crypto algorithm, e.g., GCM-AES-128. The value may be dynamically generated or a static key, which may have been preinstalled to a memory of client device 200. The validation of the authentication feature may comprise all conventional validation techniques. For example, the validation may comprise recalculating a value, e.g., an integrity check value included in the authentication feature. In some implementations, the validation may comprise comparing the recalculated value of the authentication feature with an original value which may have been preinstalled to the client device 200.

If the processing circuit 210 has authenticated the beacon, the processing circuit 210 (e.g., the one or more processors of the processing circuit 210) may restart a transmission opportunity. During the transmission opportunity, data may be forwarded to the transmit circuit 220, which may transmit data to the network, e.g., to host device 100. For example, the transmit circuit 220 may be configured to transmit data in an assigned time slot or at an assigned frequency channel.

In some implementations, the processing circuit 210 (e.g., the one or more processors of the processing circuit 210) may be configured to identify an invalid beacon based on an absence of the authentication feature and/or identification of an invalid authentication feature, meaning a received beacon may not comprise any authentication feature or may comprise a authentication feature that is not correct, e.g., a counterfeit authentication feature.

The identification of the invalid authentication feature may comprise comparing the invalid authentication feature to a preinstalled value and/or key, wherein the invalid authentication feature does not match the preinstalled value and/or key.

If the processing circuit 210 has identified an invalid beacon, e.g., received from an intruding device, the processing circuit 210 (e.g., the one or more processors of the processing circuit 210) may ignore the beacon. Ignoring the invalid beacon may comprise not restarting a transmission opportunity and not forwarding data to the transmit circuit 220. By not restarting the transmission opportunity, the transmission cycle initiated by the host device may be executed as intended and no subsequent client device may be excluded from communication due to an intruding device.

In some implementations, the client device 200 further comprises a memory, to which information corresponding to the receipt of the invalid beacon may be stored. The one or more processors of the processing circuit 210) may be communicatively coupled to the memory for providing the information to the memory. If the client device 200 receives another authentic beacon via receive circuit 230 and the processing circuit 210 (e.g., the one or more processors of the processing circuit 210) validates the authenticity of the beacon, the information corresponding to the receipt of the invalid beacon may be communicated to the host 100. For example, the information may be packed in a separate data frame or appended to a data frame which is to be transmitted to the host device 100.

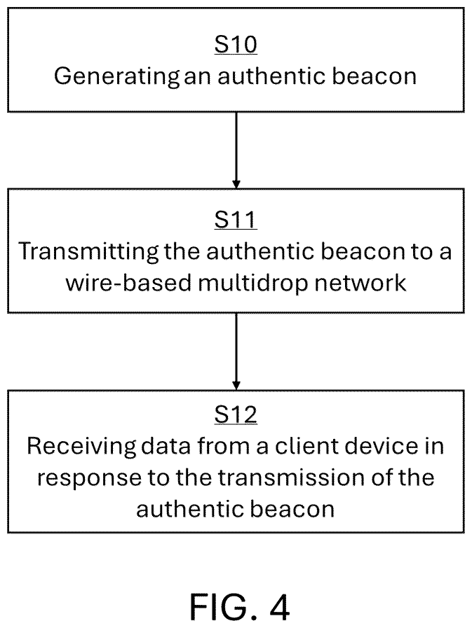

FIG. 4 shows a flow-chart illustrating a first method according to an implementation. The first method may be performed by the host device 100.

In step S10 of FIG. 4, an authentic beacon is generated comprising a base beacon and an authentication feature. The authentic beacon may be generated by the processing circuit 110 of the host device 100 in accordance with aspects of the disclosure given above.

In step S11 of FIG. 4, the authentic beacon is transmitted to a wire-based multidrop network, e.g., network 1000. The authentic beacon may be transmitted by transmit circuit 120 of host device 100. The transmission of the authentic beacon may result in synchronous initiation of a transmission cycle.

In step S12 of FIG. 4, data is received in response to the transmission of the authentic beacon. The data may be received by the receive circuit 130 of host device 100.

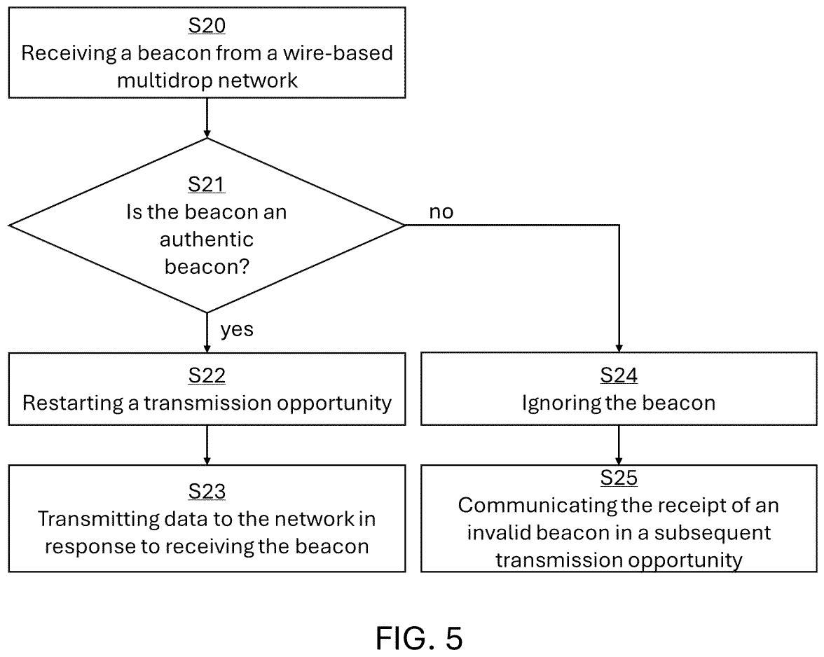

FIG. 5 shows a flow-chart illustrating a second method according to an implementation. The second method may be performed by the client device 200.

In step S20 of FIG. 5, a beacon is received by a receive circuit, e.g., receive circuit 230 of client device 200.

In step S21 of FIG. 5, the beacon is validated. The validation may be performed by a processing circuit, e.g., processing circuit 210 of client device 200 in accordance with aspects of the disclosure given above. If the beacon is an authentic beacon, step S22 may be executed, wherein a transmission opportunity is restarted. During the transmission opportunity, in step S23, data may be transmitted to the network.

If the beacon is not an authentic beacon, e.g., the beacon is an invalid beacon, step S24 may be executed, wherein the beacon is ignored, and no transmission opportunity is restarted. The receipt of the invalid beacon may be stored in a memory such that in a subsequent transmission opportunity after receiving an authentic beacon, step S25 may be performed, wherein the receipt of the invalid beacon may be communicated to the host device.

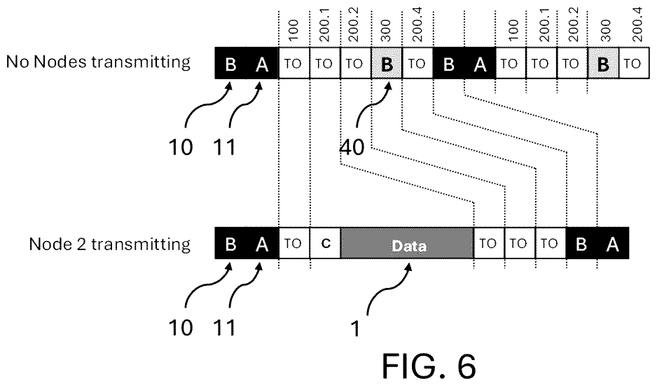

FIG. 6 illustrates one implementation of a secure synchronous initiation of a transmission cycle that may the host device 100 of FIG. 2 and client devices 200 of FIG. 3. The host device 100 may execute the method of FIG. 4 as detailed above, and the client devices 200 may execute the method of FIG. 5 as detailed above.

The authentic beacon comprising base beacon 10 and authentication feature 11, is transmitted to a network, e.g., wire-based multidrop network 1000 of FIG. 1. As a result of the transmission of the authentic beacon, all connected devices are assigned a transmission opportunity TO. As an example, during the transmission opportunity TO, client device 200.1 transmits data frame 1 to the network. A commit frame C may be transmitted previous to data frame 1 to indicate that the client device will be transmitting data to the network.

According to the example of FIG. 6, a connected device, e.g., intruding host device 300, may act as an intruder and transmit an invalid beacon 40 to the network. As the invalid beacon 40 does not comprise the authentication feature 11, the client devices may identify the invalid beacon and ignore the invalid beacon 40 such that the transmission cycle and transmission opportunities of the client devices are not restarted. The transmission cycle initiated by host device 100 using the authentic beacon may be followed as intended and, for example, no authorized client device is excluded from communication.

Subsequent to the transmission cycle initiated by the first authentic beacon, a second authentic beacon comprising base beacon 10 and authentication feature 11 may be transmitted to the network, wherein the second authentic beacon may optionally be of the same structure or of a different structure as the first beacon, e.g., containing a different authentication feature.

### ASPECTS

Some implementations are defined by the following examples:
Aspect 1. A host device comprising:
a processing circuit configured to generate an authentic beacon by providing a base beacon with an authentication feature, and
a transmit circuit configured to transmit the authentic beacon to a wire-based multidrop network for synchronous initiation of a transmission cycle.
Aspect 2. The host device of aspect 1, wherein the authentication feature is based on an encryption key.
Aspect 3. The host device of aspect 1 or 2, wherein the authentication feature is appended to the base beacon.
Aspect 4. The host device of any one of aspects 1 to 3, wherein the wire-based network is an ethernet-based network.
Aspect 5. The host device of aspect 4, wherein the wire-based network is a 10BASE-T1S-based network or a 10BASE-T1M-based network.
Aspect 6. The host device of any one of aspects 1 to 5, further comprising a receive circuit configured to receive data from a client device in response to the transmission of the authentic beacon.
Aspect 7. A client device comprising:
a receive circuit configured to receive a beacon from a wire-based multidrop network, and
a processing circuit configured to check if the beacon is an authentic beacon.
Aspect 8. The client device of aspect 7, wherein to check if the beacon is an authentic beacon comprises verifying the presence of an authentication feature of the authentic beacon.
Aspect 9. The client device of aspect 8, further configured to identify an invalid beacon based on at least one of
identifying an absence of the authentication feature
identifying an invalid authentication feature of the beacon.
Aspect 10. The client device of any one of aspects 7 to 9, further configured to restart a transmission opportunity, if the beacon is an authentic beacon.
Aspect 11. The client device of any one of aspects 7 to 10, further comprising a transmit circuit configured to transmit data to the network in response to receiving the beacon, if the beacon is an authentic beacon.
Aspect 12. The client device of aspect 9 or 10, further configured to ignore the invalid beacon such that the transmission opportunity is not restarted.
Aspect 13. The client device of any one of aspects 9 to 12, further configured to communicate receipt of the invalid beacon in a subsequent transmission opportunity.
Aspect 14. The client device of any one of aspects 7 to 13, wherein the wire-based network is an ethernet-based network.
Aspect 15. The client device of aspect 14, wherein the wire-based network is a 10BASE-T1S-based network or a 10BASE-T1M-based network.
Aspect 16. A wire-based multidrop network comprising
the host device of any one of aspects 1 to 6, and
at least one client device of any one of aspects 7 to 15.
Aspect 17. A method comprising:
generating, by a processing circuit of a host device, an authentic beacon by providing a base beacon with an authentication feature, and
transmitting, by a transmit circuit of the host device, the authentic beacon to a wire-based multidrop network for synchronous initiation of a transmission cycle.
Aspect 18. The method of aspect 17, wherein the authentication feature is based on an encryption key.
Aspect 19. The method of aspect 17 or 18, wherein the method further comprises appending the authentication feature to the base beacon.
Aspect 20. The method of any one of aspects 17 to 19, wherein the wire-based network is an ethernet-based network.
Aspect 21. The method of aspect 20, wherein the wire-based network is a 10BASE-T1S-based network or a 10BASE-T1M-based network.
Aspect 22. The method of any one of aspects 17 to 21, wherein the method further comprises receiving, by a receive circuit of the host device, data from a client device in response to the transmission of the authentic beacon.
Aspect 23. The method of aspect 18, comprising
receiving, by a receive circuit of at least one client device, a beacon from a wire-based multidrop network, and
checking, by a processing circuit of the at least one client device, if the beacon is an authentic beacon.
Aspect 24. A method comprising,
receiving, by a receive circuit of at least one client device, a beacon from a wire-based multidrop network, and
checking, by a processing circuit of the at least one client device, if the beacon is an authentic beacon.
Aspect 25. The method of aspect 24, wherein checking if the beacon is an authentic beacon comprises verifying the presence of an authentication feature of the authentic beacon.
Aspect 26. The method of aspect 25, wherein the method further comprises identifying an invalid beacon based on at least one of
identifying an absence of the authentication feature
identifying an invalid authentication feature of the beacon.
Aspect 27. The method of any one of aspects 24 to 26, wherein the method further comprises restarting a transmission opportunity, if the beacon is an authentic beacon.
Aspect 28. The method of any one of aspects 24 to 27, wherein the method further comprises transmitting, by a transmit circuit of the at least one client device, data to the network in response to receiving the beacon, if the beacon is an authentic beacon.
Aspect 29. The method of aspect 26 or 27, wherein the method further comprises ignoring the invalid beacon such that the transmission opportunity is not restarted.
Aspect 30. The method of any one of aspects 26 to 29, wherein the method further comprises communicating receipt of the invalid beacon in a subsequent transmission opportunity.
Aspect 31. The method of any one of aspects 24 to 30, wherein the wire-based network is an ethernet-based network.
Aspect 32. The method of aspect 31, wherein the wire-based network is a 10BASE-T1S-based network or a 10BASE-T1M-based network.

Although specific implementations have been illustrated and described herein, it will be appreciated by those of ordinary skill in the art that a variety of alternate and/or equivalent implementations may be substituted for the specific implementations shown and described without departing from the scope of the present implementation. This application is intended to cover any adaptations or variations of the specific implementations discussed herein. Therefore, it is intended that this implementation be limited only by the claims and the equivalents thereof.

1. A host device comprising:
a processing circuit configured to generate an authentic beacon by providing a base beacon with an authentication feature, and
a transmit circuit configured to transmit the authentic beacon to a wire-based multidrop network for synchronous initiation of a transmission cycle.

2. The host device of claim 1, wherein the authentication feature is based on an encryption key.

3. The host device of claim 1, further comprising:
a receive circuit configured to receive data from a client device in response to a transmission of the authentic beacon.

4. A client device comprising:
a receive circuit configured to receive a beacon from a wire-based multidrop network, and
a processing circuit configured to check if the beacon is an authentic beacon.

5. The client device of claim 4, wherein to check if the beacon is an authentic beacon comprises verifying a presence of an authentication feature of the authentic beacon, wherein the processing circuit is further configured to identify an invalid beacon based on at least one of:
identifying an absence of the authentication feature, or
identifying an invalid authentication feature of the beacon.

6. The client device of claim 5, wherein the processing circuit is further configured to restart a transmission opportunity, if the beacon is an authentic beacon.

7. The client device of claim 4, further comprising:
a transmit circuit configured to transmit data to the wire-based multidrop network in response to receiving the beacon, if the beacon is an authentic beacon.

8. The client device of claim 6, wherein the processing circuit is further configured to ignore the invalid beacon such that the transmission opportunity is not restarted.

9. The client device claim 5, further configured to communicate receipt of the invalid beacon in a subsequent transmission opportunity.

10. A wire-based multidrop network comprising:
a host device comprising:
a processing circuit configured to generate an authentic beacon by providing a base beacon with an authentication feature, and
a transmit circuit configured to transmit the authentic beacon to a wire-based multidrop network for synchronous initiation of a transmission cycle; and
at least one client device, wherein each client device of the at least one client device comprises:
a receive circuit configured to receive a beacon from the wire-based multidrop network, and
a processing circuit configured to check if the beacon is the authentic beacon.

11. A method comprising:
generating, by a processing circuit of a host device, an authentic beacon by providing a base beacon with an authentication feature, and
transmitting, by a transmit circuit of the host device, the authentic beacon to a wire-based multidrop network for synchronous initiation of a transmission cycle.

12. The method of claim 11, wherein the authentication feature is based on an encryption key.

13. The method of claim 11, wherein the method further comprises:
receiving, by a receive circuit of the host device, data from a client device in response to a transmission of the authentic beacon.

14. The method of claim 13, comprising
receiving, by a receive circuit of at least one client device, a beacon from a wire-based multidrop network, and
checking, by a processing circuit of the at least one client device, if the beacon is an authentic beacon.

15. A method comprising,
receiving, by a receive circuit of at least one client device, a beacon from a wire-based multidrop network, and
checking, by a processing circuit of the at least one client device, if the beacon is an authentic beacon.

16. The method of claim 15, wherein checking if the beacon is an authentic beacon comprises verifying a presence of an authentication feature of the authentic beacon, and wherein the method further comprises identifying an invalid beacon based on at least one of:
identifying an absence of the authentication feature, or
identifying an invalid authentication feature of the beacon.

17. The method of claim 16, wherein the method further comprises restarting a transmission opportunity, if the beacon is an authentic beacon.

18. The method of claim 15, wherein the method further comprises:
transmitting, by a transmit circuit of the at least one client device, data to the wire-based multidrop network in response to receiving the beacon, if the beacon is an authentic beacon.

19. The method of claim 17, wherein the method further comprises:
ignoring the invalid beacon such that the transmission opportunity is not restarted.

20. The method of claim 16, wherein the method further comprises communicating receipt of the invalid beacon in a subsequent transmission opportunity.
